(19) United States
(12) Patent Application Publication
(10) Pub. No.: US 2015/0168156 A1
(43) Pub. Date: Jun. 18, 2015

(54) ADDRESS CONVERTER AND ADDRESS ANALYZING SYSTEM USING THE SAME

(71) Applicant: Weistech Technology Co. Ltd., Taipei (TW)

(72) Inventor: WEI HSU, Taipei (TW)

(21) Appl. No.: 14/331,668

(22) Filed: Jul. 15, 2014

(30) Foreign Application Priority Data
Dec. 17, 2013 (TW) 102223821

(51) Int. Cl. G01C 21/26

(52) U.S. Cl. CPC G01C 21/26

(57) ABSTRACT

An address converter includes an address input module, a conversion processing module and a code output module. The address input module is configured to be inputted with address information. The conversion processing module is electrically coupled to the address input module and configured to receive the address information and convert the address information into an address code information. The code output module is electrically coupled to the conversion processing module and signal connected to a code receiver module of a corresponding vehicle-based address analyzing apparatus. The code output module is configured to receive the address code information from the conversion processing module and output the address code information to the code receiver module of the vehicle-based address analyzing apparatus. An address analyzing system including the aforementioned address converter and the vehicle-based address analyzing apparatus is also disclosed.

### FIELD OF THE INVENTION

The present invention relates to an address converter, and more particularly to an address converter used with a corresponding vehicle-based address analyzing apparatus. The present invention further relates to an address analyzing system.

### BACKGROUND OF THE INVENTION

For a passenger, it is quite convenient to take a taxi due to only need to tell the destination to the taxi driver without wasting the time spent in waiting and changing route in the public transport system. In addition, for a foreigner who is not familiar with the public transport system in this city, taxi is always a preferred option.

However, if the passenger is a foreigner, the taxi driver may not be familiar with the language that the foreigner passenger speaks. Thus, a difficult communication between the passenger and the taxi driver may be resulted and both may feel inconvenient.

In addition, for those passengers always taking taxis to fixed destinations, it is quite inconvenient to repeat the destination again and again to the taxi driver every ride. Even though some commercial stores provide the quick response (QR) code containing the address information to passengers' smart phones, the passengers still need to tell the taxi driver the destination in an oral manner. In this situation, the smart phone has limited help for the communication between the passenger and the taxi driver.

On the other hand, with the development of the unmanned technology in taxi field, there will be a problem to realize the communication between a passenger and a machine.

Therefore, it is quite important to develop a system capable of recording the destinations in advance, letting the taxi driver know where the passengers desired to go without the oral communication as well as capable of being applied to the unmanned-technology taxi.

### SUMMARY OF THE INVENTION

Therefore, an object of the present invention is to disclose a system capable of recording the destinations in advance, letting the taxi driver know where the passengers desired to go without the oral communication as well as capable of being applied to the unmanned-technology taxi.

The present invention provides an address converter for converting an address information and providing the converted address information to a corresponding vehicle-based address analyzing apparatus. The vehicle-based address analyzing apparatus includes a code receiver module and a vehicle-based processing module electrically coupled to the code receiver module. The code receiver module is configured to receive the converted address information. The vehicle-based processing module is configured to generate a complete address corresponding to the address information by analyzing the converted address information. The address converter includes an address input module, a conversion processing module and a code output module. The address input module is configured to be inputted with the address information. The conversion processing module is electrically coupled to the address input module and configured to receive the address information from the address input module and convert the address information into an address code information. The code output module is electrically coupled to the conversion processing module and signal connected to the code receiver module of the vehicle-based address analyzing apparatus. The code output module is configured to receive the address code information from the conversion processing module and output the address code information to the code receiver module of the vehicle-based address analyzing apparatus.

The present invention further provides an address analyzing system for converting an address information and analyzing the converted address information. The address analyzing system includes an address converter and a vehicle-based address analyzing apparatus. The address converter includes an address input module, a conversion processing module and a code output module. The address input module is configured to be inputted with the address information. The conversion processing module is electrically coupled to the address input module and configured to receive the address information from the address input module and convert the address information into an address code information. The code output module is electrically coupled to the conversion processing module and configured to receive the address code information from the conversion processing module and output the address code information. The vehicle-based address analyzing apparatus includes a code receiver module and a vehicle-based processing module. The code receiver module is configured to receive the address code information from the code output module. The vehicle-based processing module is electrically coupled to the code receiver module and configured to generate a complete address corresponding to the address information by analyzing the address code information.

In summary, through configuring the address converter to receive the address information from a user, convert the address information into the address code information and output the address code information to the corresponding vehicle-based address analyzing apparatus and configuring the vehicle-based address analyzing apparatus to generate a complete address corresponding to the address information by analyzing the address code information, the address analyzing system of the present invention can provide a taxi driver with a complete address where the user plans to go. In addition, when the address analyzing system is equipped with a memory storage unit, the user can store a plurality of destinations in the memory storage unit in advance; thus, the user can directly select the destination plan to go thereby facilitating the convenience. Because the address converter can directly output the address code information, corresponding to the address information inputted or selected by a user, to the corresponding vehicle-based address analyzing apparatus without any oral communication between the taxi driver and the user, the inconvenience resulted by the language barrier between the taxi driver and the user can be effectively avoided. In addition, it is understood that the features of the present invention is also adapted to the unmanned-technology taxi due to the address information communication from the user to the unmanned-technology taxi can totally fully rely on the address converter and the corresponding vehicle-based address analyzing apparatus, thereby facilitating the convenience.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of an address analyzing system in accordance with a first embodiment of the present invention;

FIG. 2 is a schematic diagram of an exemplary implementation of the address converter shown in FIG. 1;

FIG. 3 is a flowchart illustrating an addressing analyzing method corresponding to the address analyzing system of FIG. 1;

FIG. 4 is a schematic diagram illustrating an exemplary address converter displaying an image code;

FIG. 5 is a block diagram of an address analyzing system including a memory storage module;

FIG. 6 is a schematic diagram illustrating an exemplary address converter displaying a plurality of image codes;

FIG. 7 is a block diagram of an address analyzing system in accordance with a second embodiment of the present invention;

FIG. 8 is a schematic diagram illustrating an exemplary address converter including an image capture unit;

FIG. 9 is a flowchart illustrating an addressing analyzing method corresponding to the address analyzing system of FIG. 7;

FIG. 10 is a block diagram of an address analyzing system in accordance with a third embodiment of the present invention;

FIG. 11 is a schematic diagram illustrating an exemplary address converter including an area map unit;

FIG. 12 is a schematic diagram illustrating an exemplary address converter of FIG. 11 including an audio output unit connected to an audio transmission line; and

FIG. 13 is a flowchart illustrating an addressing analyzing method corresponding to the address analyzing system of FIG. 10.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

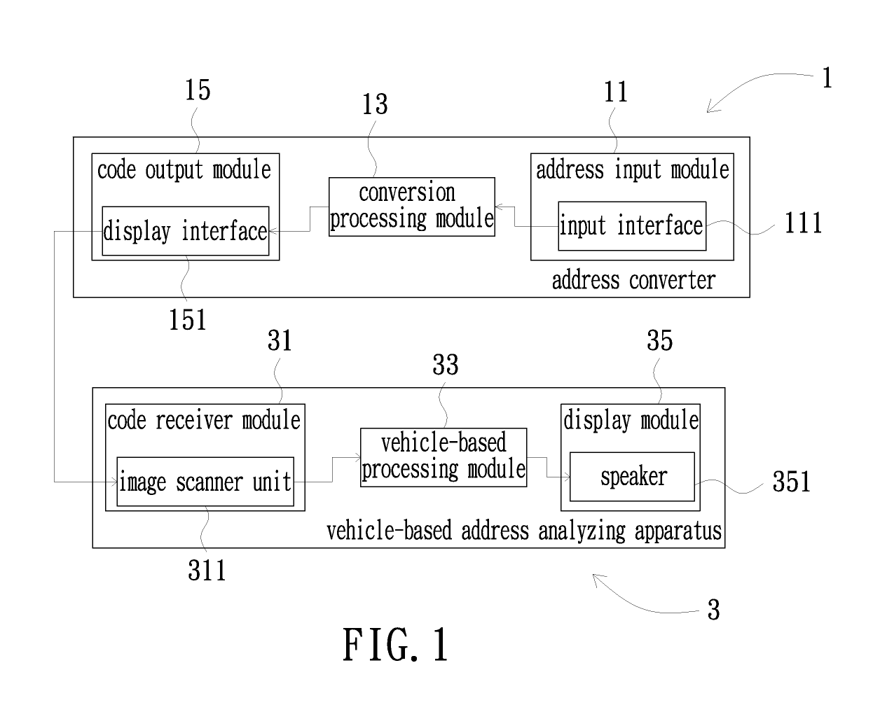

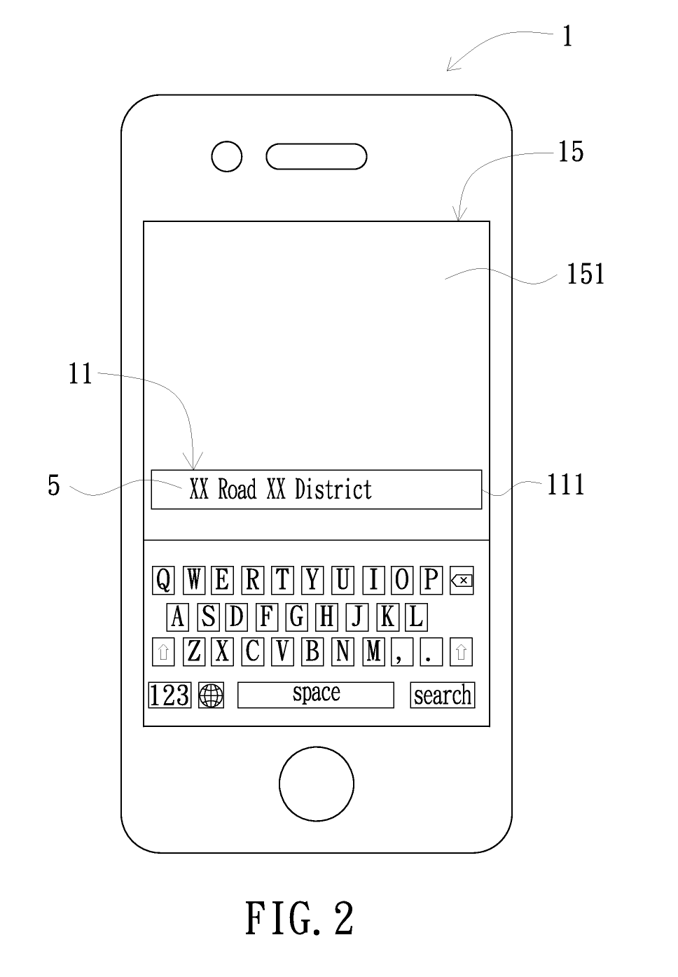

FIG. 1 is a block diagram of an address analyzing system in accordance with a first embodiment of the present invention. The address analyzing system of the present embodiment is configured to perform an address information conversion for a user thereby facilitating the address information recording and sharing. As shown in FIG. 1, the address analyzing system of the present embodiment includes an address converter 1 and a vehicle-based address analyzing apparatus 3. In the present embodiment, the address converter 1 is exemplarily implemented with a smart phone installed with corresponding conversion software, as illustrated in FIG. 2. The address converter 1 includes an address input module 11, a conversion processing module 13 and a code output module 15. The conversion processing module 13 is electrically coupled to the address input module 11 and the code output module 15. The address input module 11 includes an input interface 111. In the present embodiment, the input interface 111 is exemplarily implemented with an input area of a touch panel for a user manually inputting address information 5, as illustrated in FIG. 2. The code output module 15 includes a display interface 151, which is exemplarily implemented with a display area of the touch panel, as illustrated in FIG. 2.

The vehicle-based address analyzing apparatus 3 can be installed on a taxi and include a code receiver module 31, a vehicle-based processing module 33 and a display module 35. The vehicle-based processing module 33 is electrically coupled to the code receiver module 31 and the display module 35. The code receiver module 31 includes an image scanner unit 311. The play module 35 includes a speaker 351.

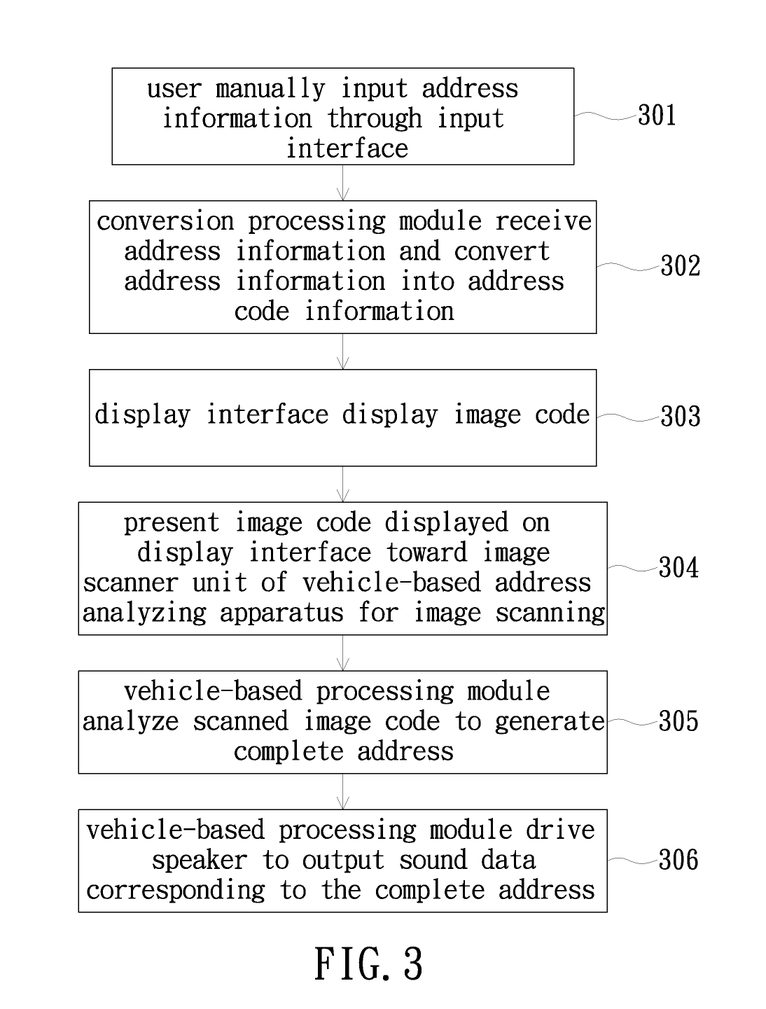

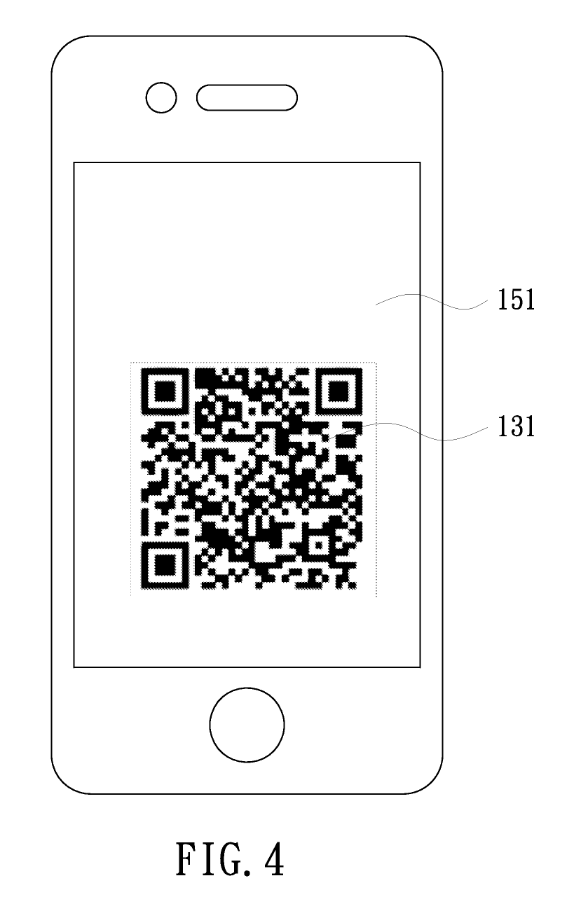

The function of the address analyzing system of FIG. 1 in the present embodiment will be described in detail as follow with a reference of FIG. 3, which is a flowchart illustrating an addressing analyzing method corresponding to the address analyzing system of FIG. 1. Please refer to FIGS. 1, 2 and 3. As shown, first, a user manually inputs the address information 5 through the input interface 111 of the address input module 11 of the address converter 1 (step 301). Next, the conversion processing module 13 receives the address information 5 from the address input module 11 and converts the address information 5 into an address code information (step 302). In the present embodiment, the address code information is exemplarily represented by an image code 131, which is a two-dimensional quick response (QR) code, as illustrated in FIG. 4.

Next, as illustrated in FIG. 4, the display interface 151 displays the image code 131 (step 303). Next, when the user takes a taxi installed with the vehicle-based address analyzing apparatus 3, the user can present the image code 131 displayed on the display interface 151 of the address converter 1 toward the image scanner unit 311 of the vehicle-based address analyzing apparatus 3, so the image scanner unit 311 can scan the image code 131 (step 304). Next, the vehicle-based processing module 33 analyzes the scanned image code 131 thereby generating a complete address corresponding to the address information 5 (step 305). Then, the vehicle-based processing module 33 drives the speaker 351 of the display module 35 to output the sound data corresponding to the complete address, thereby allowing the user to confirm the destination planed to go as well as letting the taxi driver know the destination (step 306).

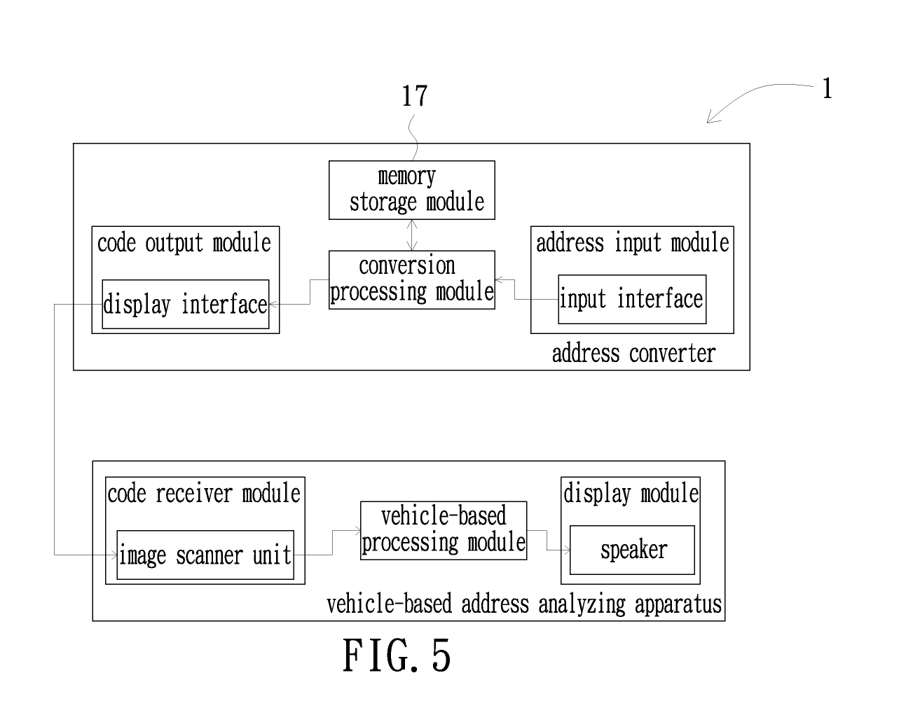

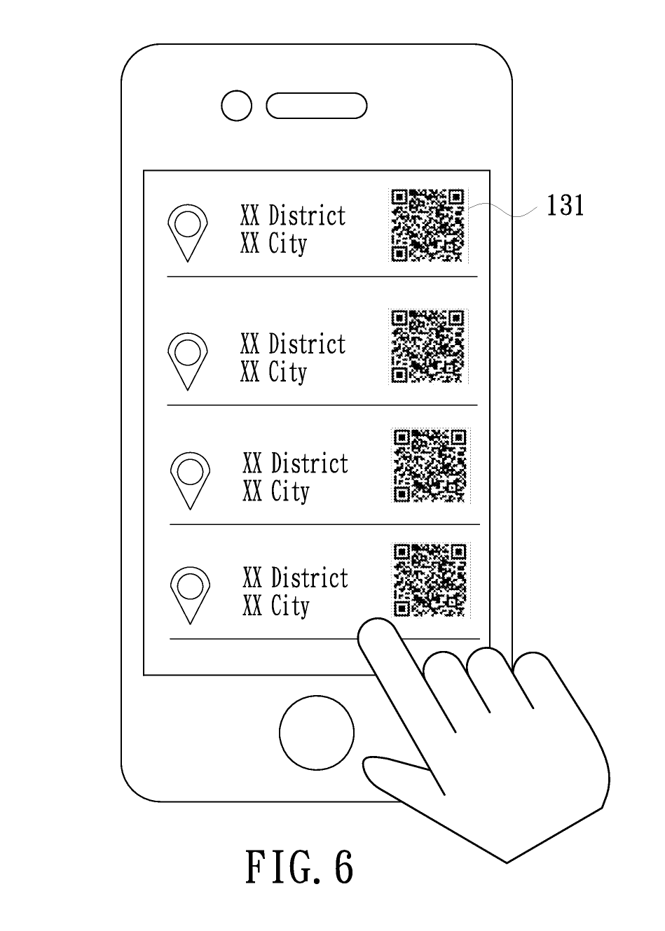

In one embodiment, as illustrated in FIGS. 5, 6, the address converter 1 may further include a memory storage module 17, which is configured to store a plurality of image codes 131. Thus, a user can directly select the destination planed to go from the memory storage module 17 and thereby facilitating the convenience.

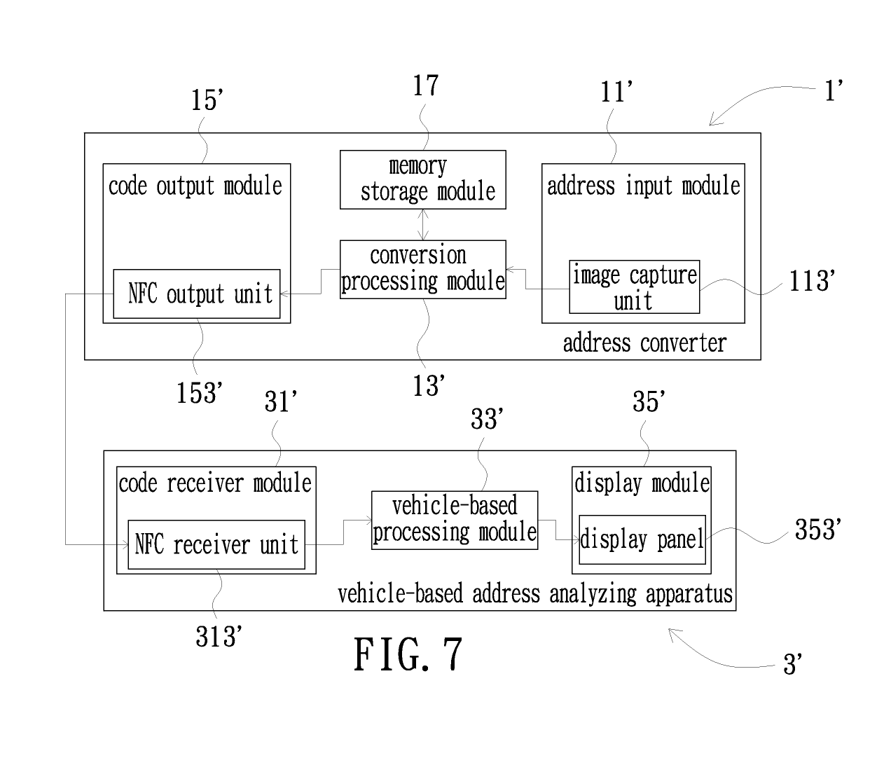

FIG. 7 is a block diagram of an address analyzing system in accordance with a second embodiment of the present invention. As shown, compared with the address analyzing system of FIG. 1 in the first embodiment, the address input module 11′ in the address converter 1′ in the present embodiment includes an image capture unit 113′, which may be implemented with a lens. The code output module 15′ in the present embodiment includes a near field communication (NFC) output unit 153′. The code receiver module 31′ of the vehicle-based address analyzing apparatus 3′ in the present embodiment includes a NFC receiver unit 313′. The display module 35′ in the present embodiment includes a display panel 353′. The aforementioned NFC output unit 153′ and the NFC receiver unit 313′ are implemented by NFC technology.

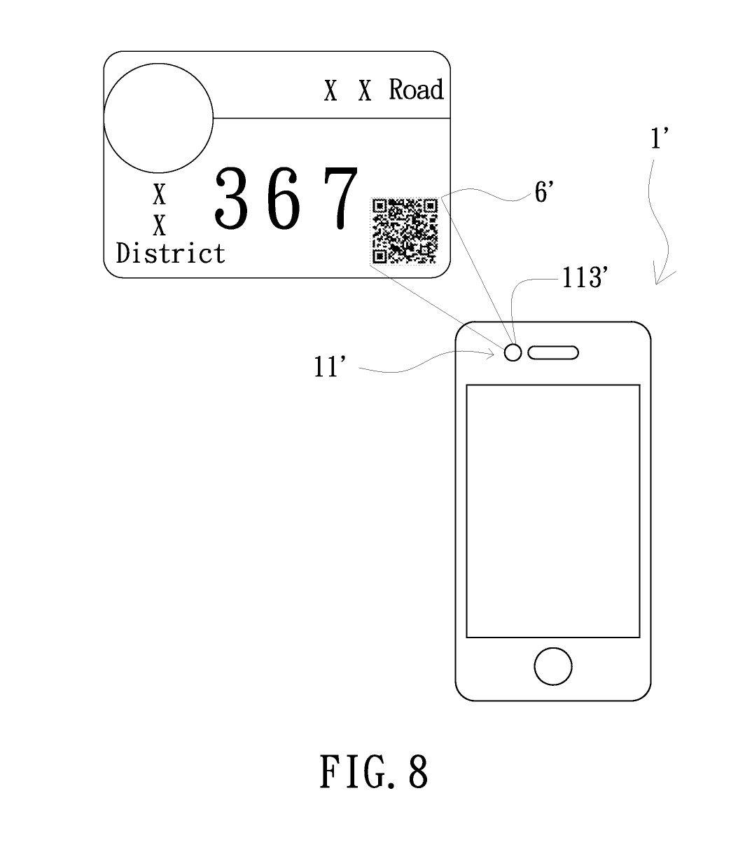

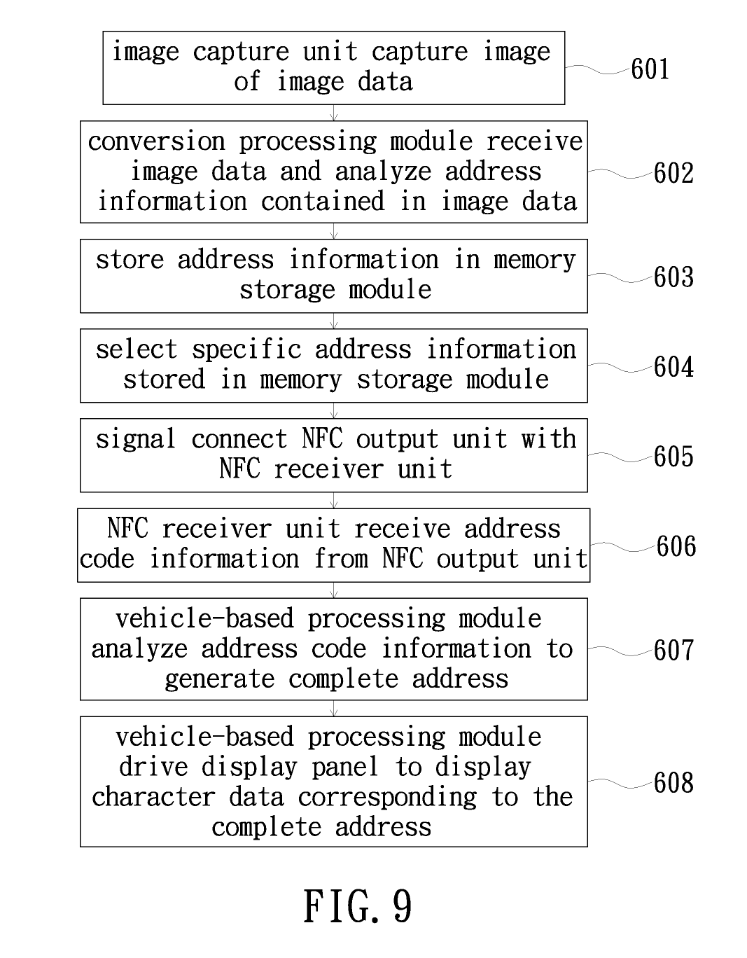

The function of the address analyzing system of FIG. 7 in the present embodiment will be described in detail as follow with a reference of FIG. 9, which is a flowchart illustrating an addressing analyzing method corresponding to the address analyzing system of FIG. 7. Please refer to FIGS. 7, 8 and 9. As shown, first, a user performs, through the image capture unit 113′, an image capturing operation on an QR code 6′ which contains the address information to generate image data (step 601). Next, the conversion processing module 13′ receives the image data from the address input module 11′, analyzes the received image data and obtains the address information contained in the QR code 6′ (step 602). Next, the conversion processing module 13′ stores the address information in the memory storage module 17′ of the address converter 1′ (step 603). Next time when the user plans to take a taxi to this address, the user can control, through a control interface (not shown), the conversion processing module 13′ to select the address information stored in the memory storage module 17′ and convert the selected address information into a corresponding address code information (step 604).

Next, the user signal connects the NFC output unit 153′ of the address converter 1′ with the NFC receiver unit 313′ of the vehicle-based address analyzing apparatus 3′ (step 605). Next, the NFC receiver unit 313′ receives the address code information outputted from the NFC output unit 153′ (step 606). Next, the vehicle-based processing module 33′ analyzes the address code information thereby generating a complete address corresponding to the address information (step 607). Then, the vehicle-based processing module 33′ drives the display panel 353′ to display the character data corresponding to the complete address, thereby allowing the user to confirm the destination planed to go as well as letting the taxi driver know the destination (step 608).

In one embodiment, the image capture unit 113′ may be designed to capture the image of a doorplate (or house number) and directly obtain the address information from the captured image of the doorplate. Thus, the present invention has a wider range of applications.

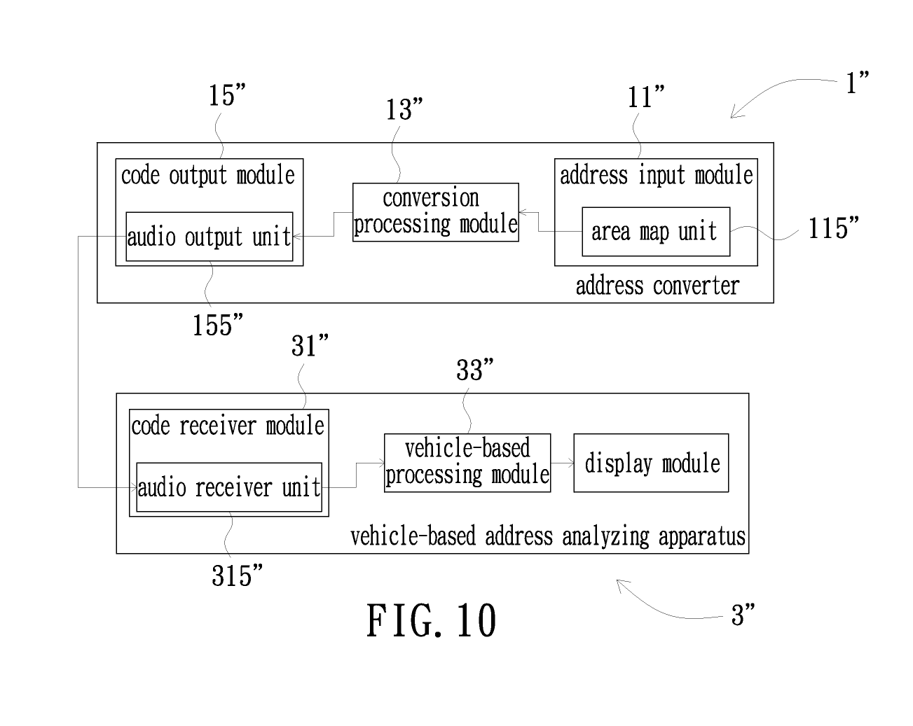

FIG. 10 is a block diagram of an address analyzing system in accordance with a third embodiment of the present invention. As shown, the address input module 11″ in the address converter 1″ in the present embodiment includes an area map unit 115″, which can be obtained from internet or preinstalled in the address converter 1″. The code output module 15″ in the present embodiment includes an audio output unit 155″. The code receiver module 31′ of the vehicle-based address analyzing apparatus 3″ in the present embodiment includes an audio receiver unit 315″.

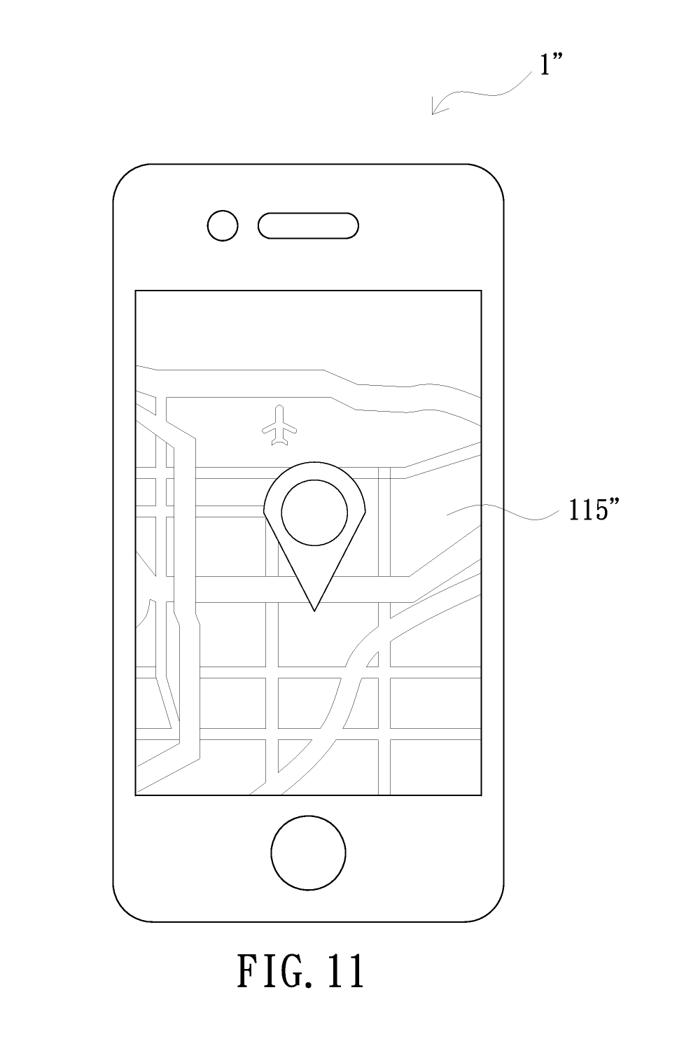

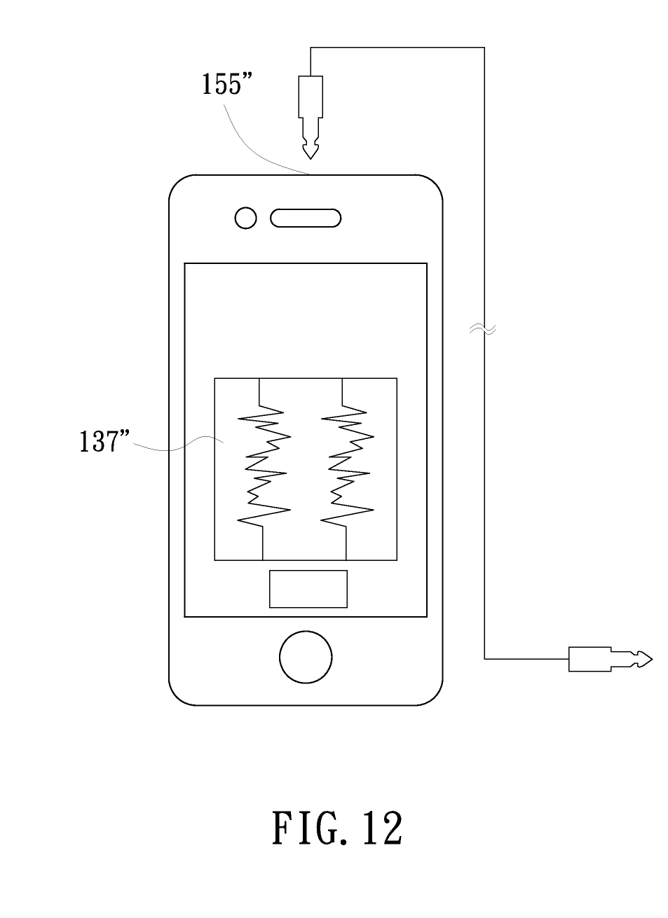

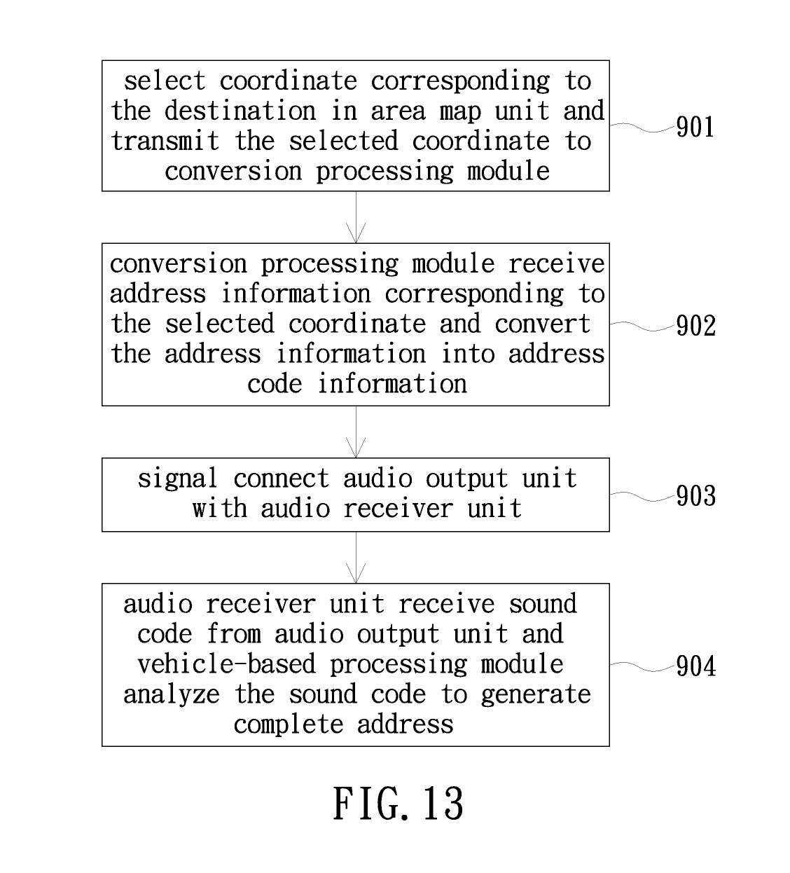

The function of the address analyzing system of FIG. 10 in the present embodiment will be described in detail as follow with a reference of FIG. 13, which is a flowchart illustrating an addressing analyzing method corresponding to the address analyzing system of FIG. 10. Please refer to FIGS. 10, 11, 12 and 13. As shown, first, when a user plans to input the address information, he/or she can select the coordinate corresponding to the destination in the area map unit 115″ as illustrated in FIG. 11 thereby transmitting the selected coordinate to the conversion processing module 13″; wherein each coordinate corresponds to one address information (step 901). Next, the conversion processing module 13″ receives the address information corresponding to the selected coordinate and converts the address information into an address code information (step 902). In the present embodiment, the address code information is exemplarily represented by a sound code 137″, as illustrated in FIG. 12. Next, the user signal connects the audio output unit 155″ of the address converter 1″ with the audio receiver unit 315″ of the vehicle-based address analyzing apparatus 3′ through, for example, an audio transmission line as illustrated in FIG. 12 (step 903). Then, the audio receiver unit 315″ receives the sound code 137″ outputted from the audio output unit 155″ and the vehicle-based processing module 33″ analyzes the sound code 137″ thereby generating a complete address corresponding to the address information (step 904).

In summary, through configuring the address converter to receive the address information from a user, convert the address information into the address code information and output the address code information to the corresponding vehicle-based address analyzing apparatus and configuring the vehicle-based address analyzing apparatus to generate a complete address corresponding to the address information by analyzing the address code information, the address analyzing system of the present invention can provide a taxi driver with a complete address where the user plans to go. In addition, when the address analyzing system is equipped with a memory storage unit, the user can store a plurality of destinations in the memory storage unit in advance; thus, the user can directly select the destination plan to go thereby facilitating the convenience.

Because the address converter can directly output the address code information, corresponding to the address information inputted or selected by a user, to the corresponding vehicle-based address analyzing apparatus without any oral communication between the taxi driver and the user, the inconvenience resulted by the language barrier between the taxi driver and the user can be effectively avoided. In addition, it is understood that the features of the present invention is also adapted to the unmanned-technology taxi due to the address information communication from the user to the unmanned-technology taxi can totally fully rely on the address converter and the corresponding vehicle-based address analyzing apparatus, thereby facilitating the convenience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An address converter for converting an address information and providing the converted address information to a corresponding vehicle-based address analyzing apparatus, the vehicle-based address analyzing apparatus comprising a code receiver module and a vehicle-based processing module electrically coupled to the code receiver module, the code receiver module being configured to receive the converted address information, the vehicle-based processing module being configured to generate a complete address corresponding to the address information by analyzing the converted address information, the address converter comprising:
an address input module, configured to be inputted with the address information;
a conversion processing module, electrically coupled to the address input module and configured to receive the address information from the address input module and convert the address information into an address code information; and
a code output module, electrically coupled to the conversion processing module and signal connected to the code receiver module of the vehicle-based address analyzing apparatus, the code output module being configured to receive the address code information from the conversion processing module and output the address code information to the code receiver module of the vehicle-based address analyzing apparatus.

2. The address converter according to claim 1, wherein the address input module comprises:
an input interface, configured to be manually inputted with the address information by a user, wherein the inputted address information is transmitted to the conversion processing module.

3. The address converter according to claim 1, wherein the address input module comprises:
an image capture unit, configured to capture an image data containing the address information, wherein the image data is transmitted to the conversion processing module for the vehicle-based processing module to analyze the address information corresponding to the image code.

4. The address converter according to claim 1, wherein the address input module comprises:
an area map unit, provided for a user to select a coordinate corresponding to the address information from the area map unit, wherein the selected coordinate is transmitted to the conversion processing module for the vehicle-based processing module to analyze the address information corresponding to the coordinate.

5. The address converter according to claim 1, further comprising:
a memory storage module, electrically coupled to the conversion processing module and configured to store the address information received by the conversion processing module.

6. An address analyzing system for converting an address information and analyzing the converted address information, the address analyzing system comprising:
an address converter, comprising:
an address input module, configured to be inputted with the address information;
a conversion processing module, electrically coupled to the address input module and configured to receive the address information from the address input module and convert the address information into an address code information; and
a code output module, electrically coupled to the conversion processing module and configured to receive the address code information from the conversion processing module and output the address code information; and
a vehicle-based address analyzing apparatus, comprising:
a code receiver module, configured to receive the address code information from the code output module; and
a vehicle-based processing module, electrically coupled to the code receiver module and configured to generate a complete address corresponding to the address information by analyzing the address code information.

7. The address analyzing system according to claim 6,
wherein the code output module comprises a display interface configured to, when the address code information is an image code, display the image code,
wherein the code receiver module comprises an image scanner unit configured to scan the image code displayed by the display interface, wherein the scanned image code is transmitted to the vehicle-based processing module for the vehicle-based processing module to analyze the address information corresponding to the image code.

8. The address analyzing system according to claim 7, wherein the image code is a quick response (QR) code.

9. The address analyzing system according to claim 6,
wherein the code output module comprises a near field communication (NFC) output unit, configured to output the address code information,
wherein the code receiver module comprises a near field communication (NFC) receiver unit, signal connected to the near field communication (NFC) output unit and configured to receive the address code information from the near field communication (NFC) output unit.

10. The address analyzing system according to claim 6,
wherein the code output module comprises an audio output unit configured to, when the address code information is an audio code, output the audio code,
wherein the code receiver module comprises an audio receiver unit configured to receive the audio code from the audio output unit.

11. The address analyzing system according to claim 6, wherein the vehicle-based address analyzing apparatus further comprises:
a display module, electrically coupled to the vehicle-based processing module and configured to receive the complete address from the vehicle-based processing module and display the complete address.

12. The address analyzing system according to claim 11, wherein the display module comprises:
a speaker, electrically coupled to the vehicle-based processing module and configured to display a sound data corresponding to the complete address by a driving of the vehicle-based processing module.

13. The address analyzing system according to claim 11, wherein the display module comprises:
a display panel, electrically coupled to the vehicle-based processing module and configured to display a character data corresponding to the complete address by a driving of the vehicle-based processing module.
